(19) United States
(12) Patent Application Publication
(10) Pub. No.: US 2007/0025884 A1
(43) Pub. Date: Feb. 1, 2007

(54) Sampling cup for microbiological suspension particles in an atmosphere and sampling device for said cup

(76) Inventors: Peter Gorner, Vandoeuvre-Les-Nancy (FR); Paul Courbon, Apremont (FR); Christian Champion, Chelles (FR); Richard Wrobel, Liverdun (FR); Olivier Witschger, Nancy (FR); Jean-Francois Fabries, Nancy (FR); Veronique Marchall, Nang (FR)

Correspondence Address: SPRINKLE IP LAW GROUP, 1301 W. 25TH STREET, SUITE 408, AUSTIN, TX, 78705, US

(21) Appl. No.: 10/547,159

(22) PCT Filed: Feb. 25, 2004
(86) PCT No.: PCT/FR04/00422

§ 371 Date: Aug. 31, 2006

(30) Foreign Application Priority Data
Feb. 26, 2003 (FR) 03/02323

(51) Int. Cl. G01N 31/22

(52) U.S. Cl. 422/102; 422/58

(57) ABSTRACT

A sampling cup for microbiological suspension particles in an atmosphere and portable sampling device provided with one such cup. The sampling cup for microbiological particles in a suspension in an atmosphere comprises a rotary cup body provided with a bottom (30) and a peripheral wall (32) which is generally cylindrical, extending from said bottom and defining with said bottom a volume filled with a trapping medium for the suspension particles. The body of the cup also comprises a crown (34) partially closing the outer section of the peripheral wall of the body and defining a passage (36) for the particles. The crown is provided with channels (38) extending in an externally outer radial manner in the direction of the periphery of the body and adapted in such a way that it produces an air flow towards the receiving medium filling the body via said passage when the body is rotated in a housing.

### RELATED APPLICATIONS

This Application claims priority Under 35 U.S.C. 119 and 365 to PCT Application No. PCT/FR 04/00422 filed 25 Feb. 2004, which in turn claims priority to FR03/02323 filed Feb. 26, 20003, each of which is incorporated by reference herein.

### TECHNICAL FIELD OF THE INVENTION

The invention relates to the sampling of atmospheric pollutants, and in particular of microbiological particles.

More particularly, the invention relates to a cup for sampling particles in suspension in an atmosphere and to a portable particle-sampling device provided with such a cup.

### BACKGROUND OF THE INVENTION

In the prior art, there are different types of devices for sampling particles in suspension in an atmosphere. Such devices comprise a sampling cup mounted on a casing provided with means of rotating the cup. The cup communicates with the ambient atmosphere to be analyzed by means of a selector for the sampling of a fraction of the aerosol to be analyzed, that is to say either the inhalable fraction, or the thoracic fraction, or the alveolar fraction.

It will be possible in this regard to refer to document FR-A-2 585 832 which describes a sampling device that can be used to analyze the alveolar fraction of an aerosol.

In the device described in this document, the cup is provided with a bottom and a cylindrical peripheral wall which extends from the bottom and which delimits with the latter a volume for trapping the particles of an aerosol to be analyzed.

A crown made of filtering foam provided with a central channel is placed in the cup so that it is in contact with the aerosol.

In operation, the cup, which is driven at a relatively high speed of rotation, that may be up to 7000 rpm, causes an aspiration of an air flow through the selector, then through the filtering foam, which holds the selected particles that are required for analysis.

This type of sampling device is suitable for the analysis of inert aerosols, that is to say of the dust type, but is not suitable for sampling microbiological aerosols.

Specifically, because of the nature of the trapping medium used, the delivery of the microbiological particles for their subsequent analysis would be relatively tricky and awkward to carry out. Furthermore, with this sampling technique, the particles to be analyzed are not on a support that makes the microbiological analysis of the aerosol easy.

### SUMMARY OF THE INVENTION

The object of the invention is to increase the possibilities of microbiological particle sampling.

For this purpose, according to the invention, the proposal is for a cup for sampling particles in suspension in an atmosphere, comprising a rotary cup body furnished with a bottom and a generally cylindrical peripheral wall extending from said bottom and delimiting with this bottom a volume filled with a medium for trapping the particles of the suspension, the cup body comprising a crown partially enclosing the end edge of the peripheral wall of the body and delimiting a passage for the particles, the crown being provided with channels extending radially outward toward the periphery of the body and suitable for generating, during the rotation of the body in a housing, an air flow toward the trapping medium, through said passage.

In addition, it becomes possible to use a trapping medium suitable for the microbiological analysis of the particles.

According to one embodiment, the channels consist of a radial grooving of the crown, this grooving being formed on a face of the cup turned toward the outside of the body.

Advantageously, the receiving medium is a collection liquid.

According to another feature of the cup according to the invention, the rotary body is intended to be rotated at a sufficient speed to push the collection fluid into an annular volume delimited by the peripheral wall, by a portion of the bottom and by the crown and drive the air flow in a helical motion toward the trapping medium.

This avoids any mechanical stresses on the particles to be retained, while they are trapped, due in particular to the tangential deposition of the particles.

According to another feature of the cup, the bottom of the body comprises a generally conical central protrusion delimiting a ramp for guiding the air flow from said passage toward the trapping medium.

The face of the crown turned toward the volume is generally frustoconical. This makes the cup easier to empty.

A housing is also provided, in which the rotary body is placed. This housing is provided with an air inlet orifice coaxial with said passage and with one or more air outlet orifices.

Preferably, the cup is made of a material that can be hot or cold sterilized.

According to the invention, also proposed is a portable device for sampling particles in suspension in an atmosphere, comprising a casing in which are placed driving means, a sampling cup mounted on the casing and intended to be rotated in a housing by the driving means and a selector of particles in suspension mounted on the housing and in communication with the sampling cup.

According to a general feature of this sampling device, the cup consists of a sampling cup as defined hereinabove.

A particularly worthwhile application of such a device relates to the sampling of the inhalable fraction of particles in suspension in the atmosphere. However, this device may also be used effectively for other fractions or for a total aerosol.

### BRIEF DESCRIPTION OF THE FIGURES

Other objectives, features and advantages of the invention will appear on reading the following description, given only as a nonlimiting example and made with reference to the appended drawings in which:

FIG. 1 is a view in axial section of a sampling device according to the invention;

FIG. 2 is a view in axial section of the cup of the device of FIG. 1;

FIG. 3 is a top view of the cup of FIG. 2; and

FIG. 4 is a view in axial section of the selector of the sampling device of FIG. 1.

### DETAILED DESCRIPTION

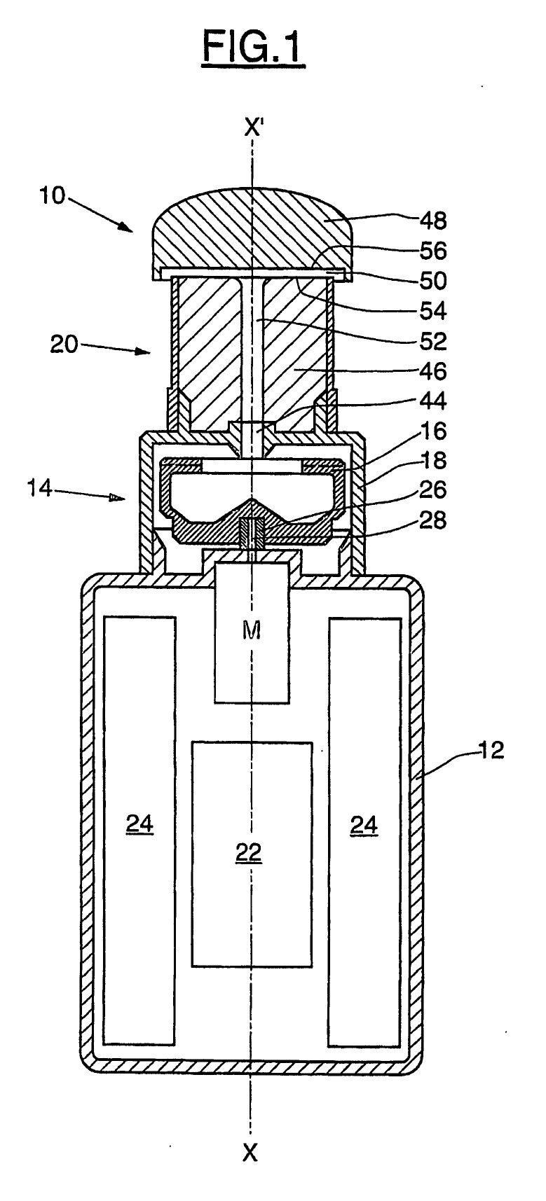

FIG. 1 shows a device for sampling particles in suspension in an atmosphere, indicated by the general reference number 10.

The sampling device shown in this figure is intended to sample the inhalable fraction of the aerosol, that is to say of a suspension of particles in the air, including microorganisms such as bacteria, spores, etc and their fragments, and the pollens and their fragments.

As is known, the inhalable fraction of an aerosol is defined by a curve, generally internationally accepted, which indicates the probability of a particle of this aerosol being retained by the part of the respiratory system concerned as a function of the size of this particle, and therefore creating an ailment therein.

The purpose of the sampling device 10 is therefore to select the incriminated particles and deliver them for the purpose of a subsequent, particularly quantitative, analysis.

The device 10 that can be seen in FIG. 1 is shown in a position considered to be vertical and comprises a general axis of symmetry X-X′. It comprises a casing 12 on which are mounted sampling means 14 consisting of a sampling cup 16 enclosed in a housing 18, and a selector 20 intended for the selection of the particles to be analyzed, according to their size, in this instance the inhalable fraction.

The casing 12 comprises an electric motor M associated with an electric power source 22 and regulation circuits 24.

Depending on the material used in the construction of the cup 16, a bearing 26 may be interposed between the motor shaft 28 and the material forming the cup 16.

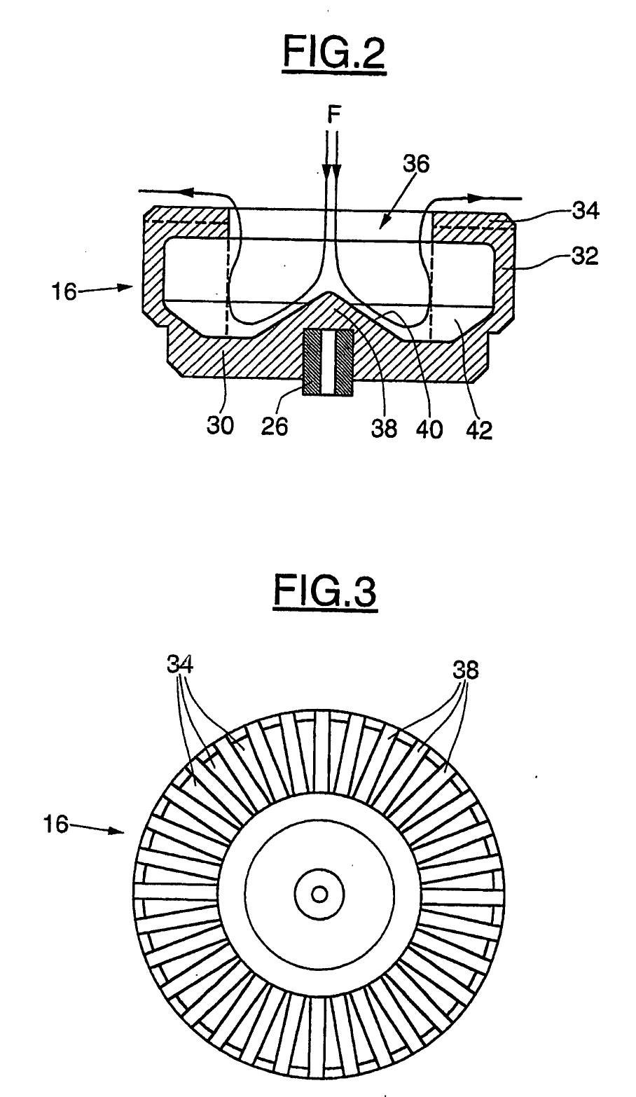

With reference to FIGS. 2 and 3, the cup 16 comprises a cup body comprising a bottom 30 and a generally cylindrical peripheral edge 32 rising substantially vertically from the peripheral edge of the bottom 30.

The top end of the edge 32, that is to say the end turned toward the selector 20, is provided with a crown 34 furnished with a circular central orifice 36 centered on the general axis X-X′ of the device 10. Thus, the crown 34 partially closes off the free end edge of the cup 16 and thus delimits a passage for an air flow drawn from the ambient atmosphere and carrying selected particles.

As shown in FIG. 3, the top face of the crown 34, that is to say the face turned toward the selector 20, is provided with a certain number of channels, such as 38, extending radially outward and obtained by grooving of the crown 34. These channels 38 are formed so as to obtain, on the top face of the cup 16, a centrifugal fan in order to create a radial air flow on this surface. As shown in FIG. 2, due to the cup 16 rotating at high speed, at a speed of the order of 7000 rpm, the flow of particles originating from the selector 20 is driven, in the cup 16, along a mostly helical trajectory, and, in the plane of FIG. 2, in the trajectory represented by the arrows F.

This motion is made easier by the presence of a protrusion 39 in the bottom 30, that is centered on the axis X-X′ and that delimits a ramp 40 for guiding the air flow originating from the passage 36 toward the peripheral wall.

To trap the particles, the internal volume of the cup 16 is filled with a trapping liquid medium 42. Various types of trapping liquid may be used in the context of the present invention, a microbiologist being capable of selecting an appropriate trapping liquid to retain predetermined particles. Note however that pure distilled water may be suitable for the sampling of a biological aerosol. As previously indicated, the cup 16 is placed in a housing 18, itself mounted on the casing 12. The housing 18 is provided with a top orifice 44, centered on the axis X-X′, through which it communicates with the selector 20 and through which the flow of selected particles is supplied to the cup 16. One or more outlet slots, made on its peripheral wall (not shown), are used to conduct the air, relieved of particles, out of the sampling device 10.

The selector 20 comprises, for its part, a selector body 46, for example made of graphite-filled plastic or of metal and a cap 48. The cap 48 and the body 46 delimit between them a calibrated passage 50 providing for the selection of the particles of the aerosol to be analyzed.

The selector body 46 has a generally cylindrical shape with an annular horizontal cross section and delimits internally an axial cavity 52 which extends from the passage 50 to the orifice 44 of the housing 18 of the sampling means 14. The facing surfaces 54 and 56 of the selector body 46 and of the cap 48 are generally flat and extend parallel with one another, perpendicular to the axis X-X′ of the device 10, and therefore perpendicular to the cavity 52. Preferably, in order to prevent any deposit of sampled particles in the cavity 52, on the top face of the body 46 turned toward the cap 48 and on the surface 56 of the cap 48, all the surfaces of the selector body 46 and of the cap likely to be in contact with the particles, that is to say the cavity 52, the top surface 54 and the surface 56 of the cap 48, are made of polished stainless steel or of nonelectrostatic plastic. Similarly, the zone of junction between the free end surface of the selector body and the cavity is rounded.

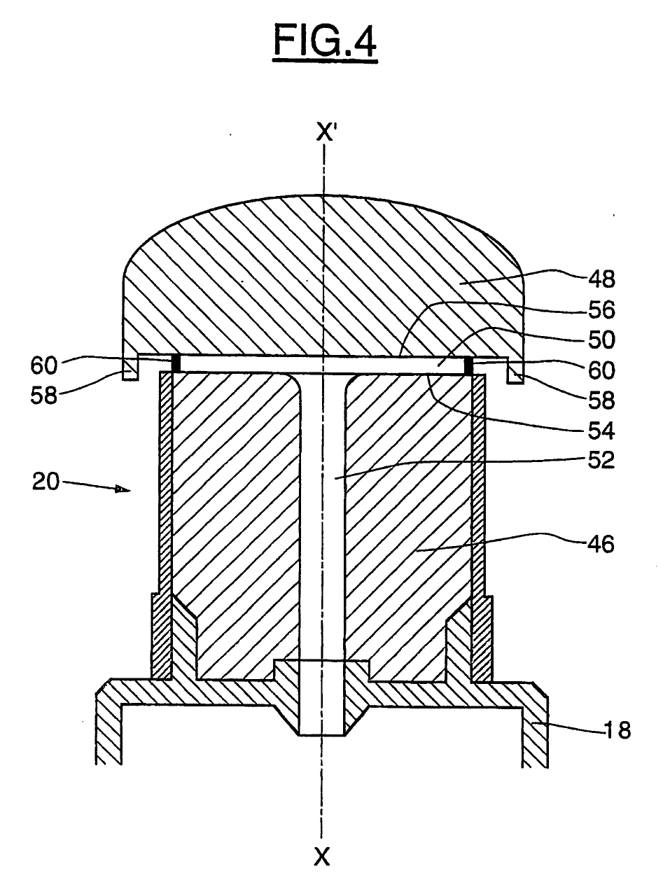

As shown in FIG. 4, the cap 48 has a bottom cross section of a greater dimension than the top cross section of the selector body 46 so that the cap extends, in the zone of the passage 50, protruding radially beyond the peripheral surface of the selector body. In the protruding zone, the cap comprises a peripheral edge 58 which extends facing the entrance of the passage so as to delimit therewith a chicane preventing any natural entry of particles into the passage 50.

Finally FIG. 4 shows that the cap 48 and the selector body 46 are fixedly attached by means of lugs 60, these lugs being placed in the vicinity of the peripheral zone of the cap 48 and of the selector body 46, that is to say in a zone in which the radial speed of the flow of particles is slower, so as to limit the losses.

In operation, as previously indicated, the motor M rotates the cup 16 which, thanks to the use of the grooves or channels 38, creates a centrifugal aspiration effect for the outside atmosphere which then enters the device through the selection passage 50 by omnidirectional aspiration, which, due to the flow created, allows only the particles of the inhalable fraction to pass. The aerosol thus sampled is forced to follow a convergent horizontal concentric flow toward the central cavity 52, which opens into the rotary cup 16.

Inside the cup, because of its rotation, as shown by the dashes, the trapping liquid extends into a volume of annular cross section delimited by the peripheral wall 32 of the cup, a portion of the bottom 30 and a portion of the crown 34. In this cup, as previously indicated, the aerosol is driven in a mostly helical motion and comes into tangential contact with the surface of the liquid 42. Thus the deposition takes place in such a manner as to prevent any mechanical impact or any impact due to sudden variations of pressure (barometric and thermal shocks), which may be traumatizing for the microorganisms and impair their physical integrity, their viability or their capacity to multiply, the centrifugal motion of the particles nevertheless being sufficient to ensure that they are deposited on the liquid 42.

After the deposition of the particles, the air flow is forced out of the device.

As previously indicated, the internal routing of the particles aspirated into the selector has been arranged so as to minimize the deposition of the particles on the inner walls of the device so that all the particles are delivered to the sampling means. Note also that, in the passage 50, the deposition of the particles by sedimentation is prevented thanks to the radial acceleration of the flow due to a progressive diminution of the cross section of aspiration in this passage 50. Furthermore, the number, the diameter and the positioning of the lugs 60 for holding the cap 48 have been chosen first to ensure the mechanical strength necessary to the rigidity and robustness of the device and, secondly, to present a minimal obstruction for -the flow so as not to hamper the constant acceleration of the flow in the radial direction.

In order to make it easier to empty the cup, the face of the crown 34 turned toward the volume filled with trapping liquid is made in a frustoconical shape, that is to say converging toward the central orifice.

The dimensions of the sampling device that has just been described and its aeraulic features have been chosen so as to obtain a correct sampling of the particles.

For example, in order to produce an easily portable device, to obtain a flow rate of approximately 10 liters per minute, the dimensions of the cup body will be chosen to be 25 mm at the orifice 36 for a rotation speed of approximately 7000 revolutions per minute.

To obtain, at the selector, a sufficient speed of the air entering the passage 50, the cap and the selector body are spaced at a distance of the order of 1 millimeter, for example 1.4 mm, and the diameter of the selector body is of the order of 30 mm, for example lying between 30.4 and 30.6 mm.

As concerns the speed of the jet from the orifice 44 toward the rotary cup, to take the air into the cup, for a speed for example of the order of 6 meters per second, the orifice will have a diameter of 6 mm.

In general, the device is designed so that its overall selectivity is most representative of that of the nasal orifices and the mouth orifice.

As previously indicated, the cup shown may also be associated with a selector of another kind. Likewise, the selector may be associated with a cup of another kind.

Note that the collection medium used is a liquid and therefore a medium that can perform the functions of collection, stabilization or conservation, and of delivery for analysis. It therefore makes it possible to prevent the particles from dehydrating and to conserve their viability, and can also be used to prevent the saturation of the medium. It is however possible to use another medium suitable for the envisaged use, for example a gelose, which is also a culture medium.

In addition, the use of a cup provided with a crown rotated at high speed makes it possible to use the sampling device in all positions.

1. A cup for sampling particles in suspension in an atmosphere, comprising a rotary cup body furnished with a bottom and a generally cylindrical peripheral wall extending from said bottom and delimiting with the bottom a volume filled with a medium for trapping the particles of the suspension, wherein the cup body comprises a crown partially enclosing the end edge of the peripheral wall of the body and delimiting a passage for the particles, the crown being provided with channels extending radially outward toward the periphery of the body and suitable for generating, during the rotation of the body in a housing, an air flow toward the trapping medium, through said passage.

2. The cup as claimed in claim 1, wherein the channels consist of a radial grooving of the crown.

3. The cup as claimed in claim 2, wherein the grooving is formed on a face of the cup turned toward the outside of the body.

4. The cup of claim 1, wherein the receiving medium is a collection liquid.

5. The cup as claimed in claim 4, wherein the rotary body is intended to be rotated at a sufficient speed to push the collection fluid into an annular volume delimited by the peripheral wall, by a portion of the bottom and by the crown and drive the air flow in a helical motion toward the trapping medium.

6. The cup as claimed in claim 1, wherein the bottom of the body comprises a generally conical central protrusion delimiting a ramp for guiding the air flow from said passage toward the trapping medium.

7. The cup as claimed in claim 1, wherein the face of the crown turned toward the volume is generally frustoconical.

8. The cup as claimed in claim 1, wherein the cup further comprises a housing in which the rotary body is placed, the housing being provided with an air inlet orifice coaxial with said passage and with one or more air outlet orifices.

9. The cup as claimed in claim 1 wherein the cup is made of a material that can be hot or cold sterilized.

10. A portable device for sampling particles in suspension in an atmosphere, comprising a casing in which are placed driving means, a sampling cup mounted on the casing and intended to be rotated in a housing by the driving means and a selector of particles in suspension mounted on the housing and in communication with the sampling cup, wherein the cup comprises a rotary cup body furnished with a bottom and a generally cylindrical peripheral wall extending from said bottom and delimiting with the bottom a volume filled with a medium for trapping the particles of the suspension, wherein the cup body comprises a crown partially enclosing the end edge of the peripheral wall of the body and delimiting a Passage for the particles, the crown being provided with channels extending radially outward toward the periphery of the body and suitable for generating, during the rotation of the body in a housing, an air flow toward the trapping medium, through said passage.

11. A method comprising using a device for the sampling of the inhalable, thoracic or alveolar fraction of particles in suspension in the atmosphere wherein the device comprises:
a portable device for sampling particles in suspension in an atmosphere, comprising:
a casing in which are placed driving means:
a sampling cup mounted on the casing and intended to be rotated in a housing by the driving means; and
a selector of particles in suspension mounted on the housing and in communication with the sampling cup;
wherein the cup further comprises:
a rotary cup body furnished with a bottom and a generally cylindrical peripheral wall extending from said bottom and delimiting with the bottom a volume filled with a medium for trapping the particles of the suspension, the cup body further comprising:
a crown partially enclosing the end edge of the peripheral wall of the body and delimiting a passage for the particles. the crown being provided with channels extending radially outward toward the periphery of the body and suitable for generating, during the rotation of the body in a housing. an air flow toward the trapping medium, through said passage.
